(19) United States
(12) Patent Application Publication
(10) Pub. No.: US 2003/0137399 A1
(43) Pub. Date: Jul. 24, 2003

(54) Extended life electromechanical lock

(76) Inventors: Gregory Paul Bauer, Masterton (NZ); Harley Franklin O'Neill, Carterton (NZ)

Correspondence Address: WITHROW & TERRANOVA, P.L.L.C., P.O. BOX 1287, CARY, NC, 27512, US

(21) Appl. No.: 10/057,836

(22) Filed: Jan. 24, 2002

(51) Int. Cl. H04Q 1/00; G05B 19/00

(52) U.S. Cl. 340/5.73; 340/5.74; 705/16

(57) ABSTRACT

A system with an electromechanical lock, such as a vending machine, has a back up power supply for use in the event power failure and includes a sleep mode for a microcontroller associated with a vending machine. Specifically, a switch decouples the microcontroller from the battery when a power interruption is detected and thus inhibits most power draining functions. A sensor associated with the electromechanical lock detects the presence of a key and draws enough power from the battery to operate the electromechanical lock such that a key user may access the interior of the vending machine.

### FIELD OF THE INVENTION

The present invention pertains to a an electromechanical lock that has an extended life in response to a loss of its power source, and particularly to such an electromechanical lock in a vending machine.

### BACKGROUND OF THE INVENTION

Vending machines are well known devices that accept payment for and dispense items such as sodas, chips, and other snacks. While some vending machines are equipped with credit or debit card readers, the majority of these machines still rely on cash as their primary form of payment acceptance.

To protect the cash contained within the machines after sales have been effectuated as well as to protect the items being vended, most, if not all, vending machines are equipped with locks that preclude unauthorized entry into the interior portions of the vending machine. In older machines, these locks may be mechanical locks, but newer machines are equipped with electromechanical locks that operate, as one might expect, both mechanically, through the insertion and turning of a key, and electrically, usually through actuation of a solenoid to move a restraining member that holds the door closed. Alternately, an external electronic key may be sensed and a motor turn a restraining member. Power to drive the electromechanical lock is obtained from the same external AC power source that provides power to the vending machine.

Further, many vending machines are now being modified such that they are “tamper resistant.” In essence, spots vulnerable to attack via crowbar or other device are isolated or protected, rendering it difficult for unauthorized individuals to open the vending machine and access the interior.

A problem arises when a vending machine with an electromechanical lock loses its power supply. When this occurs, the electromechanical lock cannot be operated. Then, an authorized individual, equipped with a proper key, cannot access the interior of the vending machine to service the vended items, retrieve cash from the cash acceptor, or the like. In tamper resistant vending machines, such a situation is extremely difficult to rectify without damaging the vending machine. The person seeking entry must wait until power is restored, which may result in food spoilage or other undesirable consequences.

Some of the newer vending machines have addressed this problem by providing a back up power supply, usually in the form of batteries, present within the vending machine. Many vending machines unfortunately consume large amounts of power. They drain power keeping the displays lit, communicating information to a remote control center, keeping electromechanical locks operational, and the like. This results in a dead battery and non-functioning locks fairly quickly if the external power source is unavailable for a non-trivial amount of time, resulting in a vending machine no better than one without the back up power supply.

### SUMMARY OF THE INVENTION

The present invention addresses some of the short-comings of the prior art by providing a sleep mode for a microcontroller associated with a vending machine when a power interruption is detected. Specifically, a switch decouples the microcontroller from the battery when a power interruption is detected and thus inhibits most power draining functions. A sensor associated with the electromechanical lock subsequently detects the presence of a key and draws enough power from the battery to operate the electromechanical lock such that a key user may access the interior of the vending machine.

The present invention may further be generalized to any environment in which an electromechanical lock is associated with a device that has multiple power draining functions. In such environments, the power draining functions are decoupled from the back up battery supply in the event of an external power loss, and the lock is selectively powered when a key is detected.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a front exterior view of a vending machine;

FIG. 2 illustrates a schematic view of a layout associated with a prior art vending machine, in particular the electromechanical lock and other associated components; and

FIG. 3 illustrates a schematic view of a layout of a vending machine according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

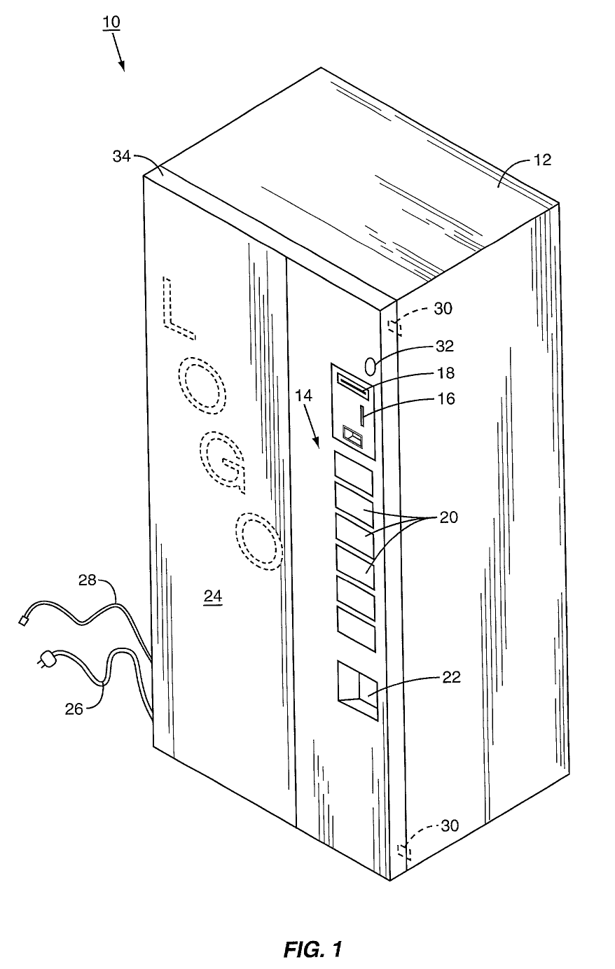

FIG. 1 illustrates an exemplary vending machine 10, in this case a soda machine that may sell, for example, COCA-COLA® or the like. The vending machine 10 comprises a housing 12 with a customer interface 14 disposed thereon. The customer interface 14 may comprise a payment acceptor, such as a change acceptor 16 and a bill acceptor 18 as well as several illuminated buttons 20 through which a selection as to products to purchase may be made, as is well understood in the industry. The product in the vending machine 10 is delivered to an outlet 22 as is further well understood. A logo section 24 may also be illuminated. The vending machine 10 may also comprise a power cord 26 to receive power from an external power source such as a conventional wall outlet or the like.

Vending machine 10 may further comprise a data communications line 28 such as a phone line, a Digital Services Line (DSL), or the like as needed or desired to achieve communications with a remote location about the status of the vending machine 10. Such status information may comprise inventory information, self-diagnostic reports, and the like as needed or desired. The communication may also be wireless as described below. In either case, suitable prearranged protocols may be used such that the remote site and the vending machine 10 are able to communicate the desired information therebetween. In an exemplary embodiment the communication passes Direct Exchange (DEX) information. Direct Exchange Uniform Communication Standard (DEX/UCS) or DEX is a standard for electronically retrievable audit data. DEX specifies a data format to enable all different types of machines and machine models to communicate electronically in a similar manner. The DEX information includes: sales, cash collections, product movement and other vending machine activities.

For additional information about the functionality and hardware associated with vending machines, reference is made to U.S. Pat. No. 6,181,981 and U.S. patent application Ser. No. 09/941,103 filed Aug. 28, 2001, both of which are hereby incorporated by reference in their entireties.

If vending machine 10 is in a high traffic area, it is possible that vending machine 10 contains a good deal of money therein. Likewise, vending machine 10 may further contain valuable inventory that may be attractive to thieves and vandals. As a result, most, if not all, vending machines 10 deployed contain a lock of some sort to protect the interior of the vending machine 10. In the exemplary vending machine 10, the lock is an electromechanical lock 30 with key interface 32 disposed on the exterior of the housing 12. In particular, electromechanical lock 30 may comprise one or more solenoid actuated bolts that are selectively positioned such that a door 34 of the housing 12 will not open when the bolts are extended. Upon detection of an external electronic key in proximity to the key interface 32, the solenoids (not shown explicitly) are actuated such that the bolts are withdrawn, and the door 34 may be opened to access the interior of the housing 12. In this manner, authorized personnel may retrieve money from the vending machine 10 and restock inventory as is well understood. Note that other types of electromechanical locks may be used with the present invention, such as the previously mentioned motor locks and the like.

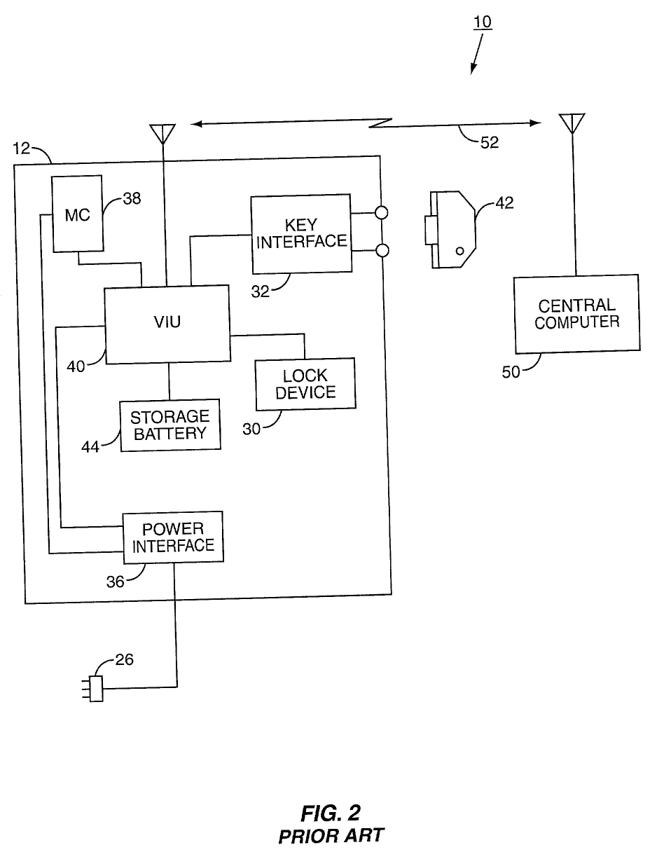

FIG. 2 illustrates, schematically, some of the components which may be found within housing 12 of a prior art vending machine 10. Specifically, power cord 26 connects to an internal power interface 36. The internal power interface 36 may comprise a transformer to step up or down the voltage from the wall outlet and/or an AC to DC converter if needed or desired. Such power interfaces are well known to those of ordinary skill in the art.

A microcontroller 38, such as a computer microprocessor or other controller is likewise positioned within the housing 12. In an exemplary embodiment, the microcontroller is on a printed circuit board with a memory element (not shown) and other electronic circuitry such as a vending interface unit (VIU) 40. The VIU 40 may be integrated with the microcontroller or distinct therefrom as needed or desired. The VIU 40 is essentially responsible for translating commands from the microcontroller 38 into outputs that are intelligible to other components in the vending machine 10. For example, upon insertion of a dollar bill into the bill acceptor 18, the VIU 40 operates the scanning device that determines the denomination and acceptability of the bill inserted. This determination may ultimately be done by the processing power of the microcontroller 38, but the VIU 40 contains the hardware from which the determination is made. The VIU 40 then displays to the consumer the dollar value of the credit the consumer has with the vending machine 10. Upon selection of a button 20, the VIU 40 receives the input from the button 20 and operates a mechanical latch (not shown) to release the product to the outlet 22. Again, these functions, and others germane to the vending machine 10 may be done with the assistance of the processing power of the microcontroller 38 as needed or desired. The elements that provide this functionality, the microcontroller 38, and other components within the vending machine 10 all comprise power draining elements as would be well understood by those of ordinary skill in the art.

The VIU 40 receives input from the key interface 32 about whether an external electronic key 42 is present and, with the microcontroller 38, determines if the key 42 is authorized to open the lock 30. If the determination is that the key 42 is authorized, the VIU 40 sends an appropriate instruction to the solenoids (or other locking mechanism) in the lock 30 and the lock 30 is opened. VIU 40 may also be responsible for communicating to a remote central computer 50 such as by a wireless communications protocol (generally labeled 52) as previously discussed and as discussed in U.S. Pat. Nos. 6,181,981 and 5,207,784, which is hereby incorporated by reference in its entirety. In an alternate embodiment, the communication is performed over a land line, such as phone line 28.

Communications to the remote central computer 50 may relate to the inventory still resident within housing 12; power status updates; accounting information; DEX data; and the like. Appropriate encryption and security protocols may be used where proprietary information is being transmitted.

Microcontroller 38 monitors, through an appropriate sensor (not shown explicitly), such as a voltmeter, ammeter, or the like, whether internal power interface 36 is receiving power through power cord 26. In the event that a power loss is detected, microcontroller 38 instructs VIU 40 to draw power from back up power supply 44, which in an exemplary embodiment is a battery. The power supply could also be a capacitor, a solar cell or the like.

Back up power supply 44 is charged by VIU 40 when power is normally flowing through the internal power interface 36, and depleted by demands made upon it when power is not coming from internal power interface 36. As noted earlier, this arrangement results in the draining of the back up power supply 44 such that it has insufficient power to operate lock 30.

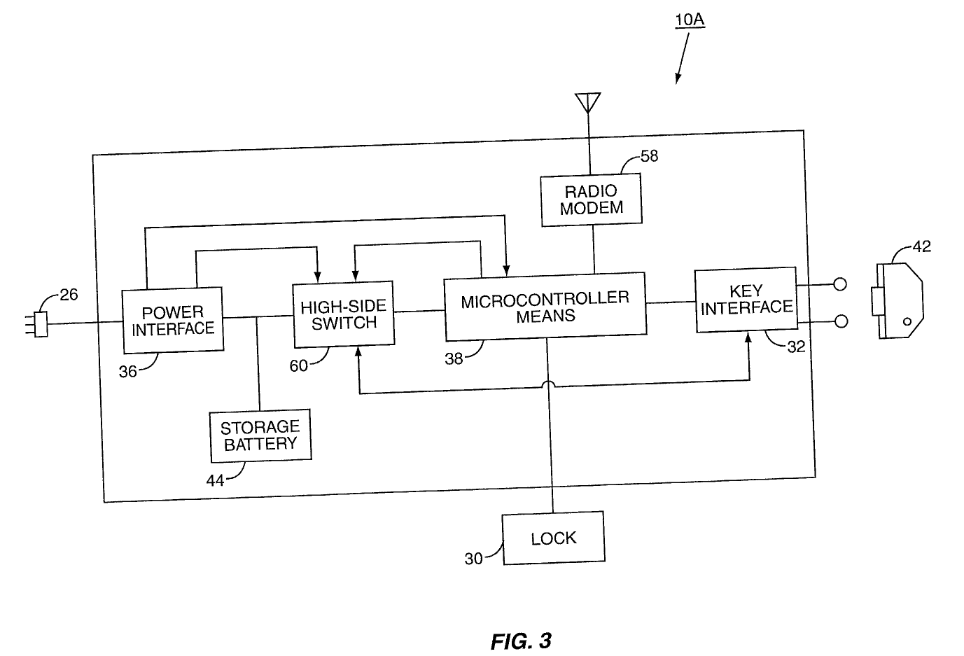

The present invention helps prolong the lifetime of a back up power supply, such as back up power supply 44 by putting the vending machine 10A into a slepe mode, with the structure illustrated in FIG. 3. In the embodiment of FIG. 3, elements similar to elements from FIG. 2 are numbered similarly. Power is introduced to the vending machine 10A via the power cord 26 where it is received by the power interface 36. Again, power interface 36 may comprise transformers or converters as needed or desired.

Microcontroller 38 receives a signal from a sensor (again not shown explicitly) associated with power interface 36 as to whether a power signal is present from the external power supply. While it is possible that the sensor may be within the microcontroller 38, this is unlikely. In the exemplary embodiment, the sensor is positioned proximate or within the power interface 36 and sends a signal to the microcontroller 38. This signal may also be indicative of a blown internal fuse or other internal power failure. Essentially, this signal should be sent anytime that switch 60 is not receiving power from power interface 36. Power interface 36 also sends a signal to the switch 60 indicating the availability of power at power interface 36. If the switch 60 receives this signal, switch 60 remains operative to pass power to the various power draining elements within the vending machine 10A as part of its normal operation. Back up power supply 44 is charged by the power coming from the external power supply as needed. In an exemplary embodiment, the back up power supply 44 comprises a twelve volt gel cell storage battery, but could be a solar cell, a capacitor, or the like.

Typically, microcontroller 38 uses either land line 28 (FIG. 1) or wireless communications device 58 to send periodic updates to a remote central computer 50, as previously described. In an exemplary arrangement, such communications are made once every twenty-four hours. In the event of power loss at power interface 38, the microcontroller 38 sends a signal to switch 60 to draw power from back up power supply 44 until such a time as microcontroller 38 has an opportunity to send the periodic report. Microcontroller 38 may store a flag in the memory that power has been lost and no report has been sent. As long as that flag is present, microcontroller 38 instructs switch 60 to draw power from back up power 44. Once the report has been sent—and the report may contain information about the loss of power—the flag may be removed and microcontroller 38 may instruct switch 60 to operate such that power is decoupled from the various power draining elements of the vending machine 10A. This effectively puts the vending machine 10A into a sleep mode, wherein power is conserved. Another flag may be set in memory that the vending machine 10A has communicated with the remote central computer 50 and that power may be decoupled.

This decoupling preserves the power contained with the battery elements of the back up power supply 44 for future needs, like opening the electromechanical lock 30. For example, when key interface 32 detects the presence of an external electronic key 42, a signal is sent to switch 60 to recouple the back up power supply 44 to the power draining elements within the vending machine 10A. This signal may draw power from the key 42 when the key 42 is a powered key; the key interface 32 may have a trickle power drain on back up power supply 44; or key interface 32 may have its own back up power supply (not shown) that is not decoupled as needed or desired. Switch 60 sends power to microcontroller 38 that invokes its power up routine. Microcontoller 38 receives a signal from the key interface 32 that an external electronic key 42 is present. Microcontroller 38 then determines if the key 42 is authorized to unlock the vending machine 10A. If that determination is positive, the microcontroller 38 commands lock 30 to open. If that determination is negative, an error message may be displayed and the switch 60 is commanded to decouple the power draining elements from the back up power supply 44, returning the vending machine 10A to a sleep mode.

In the absence of the sleep mode of the vending machine 10A, the back up power supply 44 may be drained of power by the various power draining elements such as the illuminated logo section 24, the activities of the microcontroller 38 and its efforts to communicate with the remote central computer 50, and the like.

In addition to opening the lock 30, microcontroller 38 may further run a routine to determine if the remote central computer 50 has been contacted about the power loss situation by referencing the flag discussed previously. The routine may also comprise a time delay such that the user of the external electronic key 42 has time to open and service the vending machine 10A. If by some chance, the flag is not set, meaning that the vending machine 10A has not communicated with the remote central computer 50, microcontroller 38 will send a signal to keep switch 60 operative to supply power until the normal routines of the microcontroller 38 cause a communication to be made to the remote central computer 50, at which time the appropriate flag will be set and the switch 60 instructed to decouple the power draining devices from the back up power supply 44.

While a vending machine has been discussed as the preferred embodiment, the present invention is applicable to any device or system that relies on electromechanical locks and intermittently back up power supplies, while having power draining elements associated with the back up power supply. Thus, e.g., a computer server that has an electromechanical lock to protect a hard drive containing sensitive material could use the present invention. Other devices and systems are also contemplated.

Those skilled in the art will recognize improvements and modifications to the preferred embodiments of the present invention. All such improvements and modifications are considered within the scope of the concepts disclosed herein and the claims that follow.

What is claimed is:

1. A system for conserving back up power in the absence of an external power source, comprising:
an internal power interface that receives power from an external power source and supplies power to the system;
an electromechanical lock that normally receives power from said internal power interface;
at least one power draining device associated with said system that receives power from said internal power interface;
a back up power supply that supplies power to said electromechanical lock and said at least one power draining device upon power loss at said internal power interface; and
a switch that decouples said at least one power draining device and said electromechanical lock from said back up power supply after power loss at said internal power interface;
said electromechanical lock selectively powered by said back up power supply after detection of an external electronic key.

2. The system of claim 1, wherein said at least one power draining device comprises at least a microcontroller, said microcontroller determining if power has been lost at said internal power interface.

3. The system of claim 1, wherein said back up power supply comprises at least one battery.

4. The system of claim 1, wherein said at least one power draining device is selectively powered by said back up power supply after detection of the external electronic key.

5. The system of claim 1, further comprising a key interface associated with said electromechanical lock, said key interface adapted to send a signal indicative of the presence of the external electronic key to said switch to recouple said electromechanical lock to said back up power supply.

6. The system of claim 1, wherein said internal power interface sends a signal to said switch indicative of the presence of external power such that said switch couples said electromechanical lock and said at least one power draining devices to said internal power interface for powering the same when external power is present.

7. The system of claim 2, further comprising a remote communications device operatively connected to said microcontroller and that communicates with a remote central computer.

8. The system of claim 7, wherein said remote communications device is selected from the group consisting of: a wire based communications device and a wireless communications device.

9. The system of claim 7, wherein said microcontroller, after determining that power has been lost at said internal power interface, draws power from said back up power supply until communication has been achieved with the remote central computer.

10. The system of claim 7, wherein said microcontroller is selectively powered by said back up power supply after detection of the external electronic key.

11. The system of claim 10, wherein said microcontroller determines if a communication has been sent to the remote central computer after being powered by said back up power supply.

12. The system of claim 1, wherein said at least one power draining device comprises an illuminated display, a customer interface, and a VIU.

13. A device for conserving back up power in the absence of an external power source coupled to an external power port to provide power to an electromechanical lock, comprising:
an external power port that receives power from the external power source;
an electromechanical lock that normally receives power from the external power port;
at least one power draining device that receives power from the external power port; and
a back up power supply that selectively supplies power to said electromechanical lock from said back up power supply after detection of a power loss at the external power port, said selective power supplying based on detection of an external electronic key.

14. A vending machine having an internal compartment that is accessible through an external electronic key, the vending machine comprising:
a power input that receives power from an external power supply;
a back up power supply for supplying power to the vending machine when power is not received at said power input;
a switch operatively associated with said power input and said back up power supply;
a customer interface requiring power to function and through which goods are vended;
a microcontroller that controls said customer interface and requires power to function;
an electromechanical lock for preventing access to the internal compartment of the vending machine, said electromechanical lock requiring power to function;
a key interface receiving a signal from the external electronic key when the key is proximate said interface, said key interface associated with said electromechanical lock; and
said switch decoupling said customer interface, said microcontroller, and said electromechanical lock from said back up power after detection that power is not present at said power input, said switch selectively recoupling power to at least said microcontroller and said electromechanical lock when the external electronic key is proximate said key interface.

15. The vending machine of claim 14, further comprising a communications unit for communicating with a remote location information relating to the vending machine, said communications unit requiring power and being decoupled from said back up power after detection that power is not present at said power input.

16. The vending machine of claim 14, wherein said switch is operative to convey power to said microcontroller when power is present at said power input.

17. The vending machine of claim 15, wherein said microcontroller controls said switch to keep power coupled to said microcontroller and said communications unit until said communications unit has sent the information relating to the vending machine to the remote location, whereupon said microcontroller allows said switch to decouple said back up power supply.

18. The vending machine of claim 17, further comprising a memory associated with said microcontroller, said memory retaining information relating to whether said communications unit has sent the information relating to the vending machine to the remote location after power loss at said power input.

19. The vending machine of claim 15, wherein said communications unit is selected from the group consisting of a wireless communications unit and a wirebased communications unit.

20. The vending machine of claim 14, wherein said back up power supply comprises at least one battery.

21. The vending machine of claim 14, wherein power is drawn from said back up power supply when power reaches said power input, but fails to reach said switch.

22. The vending machine of claim 14, wherein said recoupling lasts long enough for an individual to access the internal compartment.

23. A method of controlling a vending machine, comprising:
powering the vending machine with an external power source;
decoupling power draining elements within the vending machine from any power source after detection of failure of power in the vending machine; and
selectively coupling an electromechanical lock to a back up power supply through a switch such that the electromechanical lock may be operated after detection of an external electronic key proximate the vending machine.

24. The method of claim 23, further comprising coupling power draining elements to the back up power supply through the switch upon detection of an external electronic key proximate the vending machine.

25. The method of claim 23, further comprising detecting proximity of the external electronic key with a key interface positioned on the vending machine.

26. The method of claim 23, further comprising communicating with a remote location periodically.

27. The method of claim 26, wherein said decoupling occurs after a communication with the remote location.

28. The method of claim 26, wherein communicating with a remote location periodically comprises wirelessly communicating with a remote location.

29. The method of claim 23, wherein decoupling power draining elements within the vending machine comprises decoupling a microcontroller from any power source.

30. The method of claim 26, wherein communicating with a remote location comprises communicating over a wire based network.

31. The method of claim 27, further comprising storing an indicator that the communication has occurred.

32. A method of controlling a system, comprising:
powering the system with an external power source;
decoupling power draining elements within the system from any power source after detection of failure of power in the system machine; and
selectively coupling an electromechanical lock to a back up power supply through a switch such that the electromechanical lock may be operated occurring after detection of an external electronic key proximate the system.

33. The method of claim 32, further comprising coupling power draining elements to the back up power supply through the switch upon detection of an external electronic key proximate a sensor associated with the system.

34. The method of claim 32, further comprising detecting proximity of the external electronic key with a key interface associated with the system.

35. The method of claim 32, further comprising communicating with a remote location periodically.

36. The method of claim 35, wherein said decoupling occurs after a communication with the remote location.

37. The method of claim 35, wherein communicating with a remote location periodically comprises wirelessly communicating with a remote location.

38. The method of claim 32, wherein decoupling power draining elements within the system comprises decoupling a microcontroller from any power source.

39. The method of claim 35, wherein communicating with a remote location comprises communicating over a wire based network.

40. The method of claim 36, further comprising storing an indicator that the communication has occurred.
